(19) United States
(12) Patent Application Publication
(10) Pub. No.: US 2020/0242163 A1
(43) Pub. Date: Jul. 30, 2020

(54) Underground oil and/or gas well activity monitoring and notification system

(71) Applicant: Tracfrac Inc, Rapid City, SD (US)

(72) Inventors: Robert Lindberg, Bismarck, ND (US); Jason Powell, Fargo, ND (US); Luke R. Helm, Fargo, ND (US); Edward P. Schwind, Fargo, ND (US); Daniel D. Klein, Ariska, ND (US)

(21) Appl. No.: 16/775,068

(22) Filed: Jan. 28, 2020

Related U.S. Application Data
(60) Provisional application No. 62/797,836, filed on Jan. 28, 2019.
(60) Provisional application No. 62/937,059, filed on Nov. 18, 2019.

(51) Int. Cl. G06F 16/909; G06F 16/9035; G06F 9/54; H04L 29/08

(52) U.S. Cl. CPC G06F 16/909; G06F 16/9035; H04L 67/32; H04L 67/12; G06F 9/542

(57) ABSTRACT

A database of oil and/or gas wells, and system which determines distances of activities performed on one or more oil and/or gas wells and the oil and/or gas wells offset to the activity(ies), provides electronic, interface, or physical notifications offset well operators of actions that might affect the offset operators' wells, and to find information about upcoming well activity(ies) that could affect offset wells. The activities can be hydraulic fracturing.

This application claims priority from provisional application No. 62/797,836, filed Jan. 28, 2019, and from provisional application No. 62/937,059, filed Nov. 18, 2019, the entire contents of both of which are herewith incorporated by reference.

### BACKGROUND

In areas with oil and/or gas wells, pressure changes in one oil and/or gas well often affects another that is close by.

For example, hydraulic fracturing or “fracking” of one oil and/or gas well can cause a change in the pressure of neighboring oil and/or gas wells. When hydraulic fracturing or other well operations are carried out in neighboring wells, it is common for other wells to be affected.

### SUMMARY OF THE INVENTION

The present application describes a computer program and programmed computer with a portal, where the system determines wells offset from a downhole activity on another well or set of wells, and provides electronic, interface, or physical notifications to offset well operators of actions that might affect the offset operators' wells, and to find information about upcoming actions, such as hydraulic fracturing, that could affect offset wells.

Other embodiments are described herein.

### BRIEF DESCRIPTION OF THE DRAWINGS

In the Drawings:

FIG. 1 shows a flowchart of operation;

FIG. 2 shows a flowchart of scheduling activity;

FIG. 3 shows determining proximity;

FIG. 4 shows the radius method;

FIG. 5 shows the box method

FIG. 6 shows the curve method

FIG. 7 shows the points method; and

FIG. 8 shows the distance calculation method.

### DETAILED DESCRIPTION

Embodiments describe a system formed of programmed computers, which are programmed to form a system and portal that allows an operator of an oil and/or gas well to notify other operators that a downhole activity may affect the offset wells. One embodiment defines the operation as being hydraulic fracturing, however it should be understood that the operations could be any operation carried out on an oil/and or gas well, such as enhanced oil recovery methods.

According to an embodiment, information about the well location, as well as information about the geometry of the well is obtained. The geometry is obtained, as explained herein, as a wellbore or set of points, that is/are compared to other wellbores or other known sets of points. In other embodiments, this can be determined as actual well geometry and/or depth from actual data or alternatively as an assumed size. Data using a set of points is used to determine a box perimeter, radius, or multiple radii of the well as a function of depth and may be compared to a known wellbore geometry.

An embodiment as described herein assumes that users will be hydraulically fracturing their wells. Hydraulic fracturing uses large quantities of water and sand under pressure within a wellbore to fracture the rock to increase production. The increase in pressure caused by hydraulic fracturing can require offset wells, especially that may have underground connections, communication, or permeability, to be shut down or otherwise prepared during the hydraulic fracture operation.

Based on well location and geometry, the system finds offset operators whose wells may be affected by the hydraulic fracturing of a nearby well, or more generally, the programmed computer is programmed to determine how a user's actions on their wells can affect other neighboring wells. Embodiments describe how the distance between wells is determined, how the notification is determined, the locations are determined, and also allows giving the operators opportunity to learn from actions happening at previous times.

In an embodiment, the system is set up by initially determining a database of wells including their known locations and geometries, operators, and other information. An interface is created to allow the operators to establish their accounts, modify well information and input user data, set the ranges at various levels including account regions or groupings of wells, as well as individual wells. All of this can be done on a user interface of a computer for example connected to the Internet, and as described herein.

An embodiment refers to “well activities”, which can including hydraulic fracturing or any other well activity.

The user then carries out an initial account set up where the user, usually an oil and gas operator, logs into the website and creates an account by entering conventional information such as their personal, company and billing details. The user then sets up global proximity ranges to base offset well activity reporting. The user sets up one or more email addresses which will receive notifications. Part of the set up can be the states or regions in which to receive service. Users can also enter or select legal operating names which may be different for different states and regions.

After the initial setup, the system carries out its functions as described herein. The functions can include login and logout, test email delivery and receipt, and views which allow the user to see its and others' upcoming and past well activity, listing of offset wells, maps to visualize parent and child well activity, and these activities grouped in well pads or offset wells rather than individual wells. By default, users choose accounts settings to display offset well activity in 6-month future and past increments, but other ranges of dates and times are possible.

The user can also view wells assigned to their account and/or user, and can schedule, reschedule and cancel upcoming hydraulic fractures or other well activity. In addition, the users can determine if a well is offset to an upcoming hydraulic fracture or other well activity, and save modifications to well and other account data.

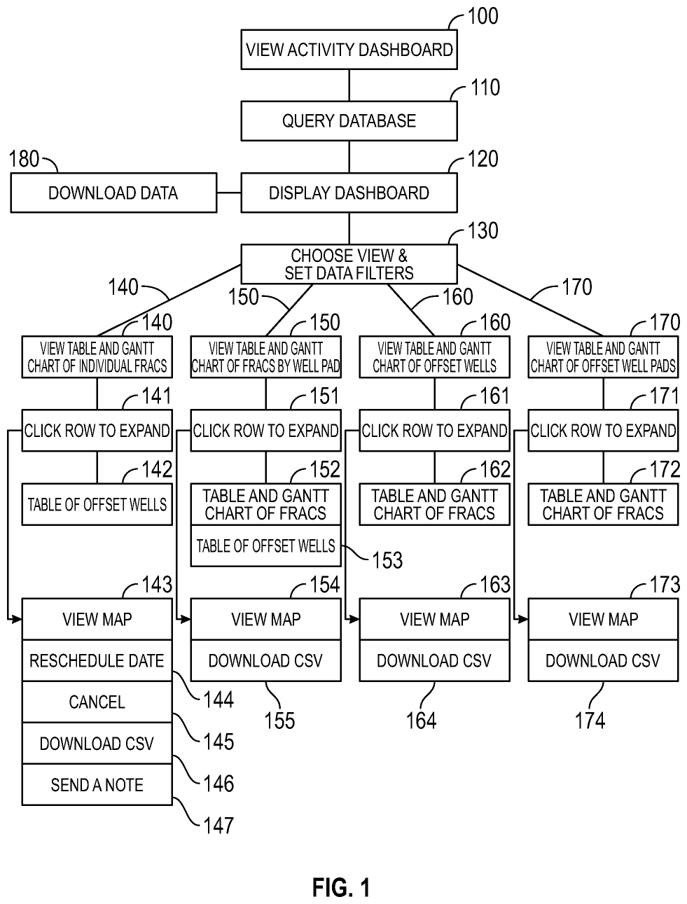

FIG. 1 illustrates a flowchart showing the basic operation that is carried out by a user opening their interface with views all of all well activity and known offsets provided by the platform. Based on the setup, the system stores information about all hydraulic fracture activity and offset well determinations.

At 100, the user selects to view all upcoming hydraulic fracture activity associated with the user's account. A query at 110 is executed on the database to match the user account to all the affiliated companies and affiliated wells with the user account, and find any upcoming well activity offset to those wells or established by the user that have been entered into the database. Wells owned by other operators offset to the user's well activities are also identified, using the techniques described herein.

A dashboard of activity is presented to the user on the screen at 120. The user may view the dashboard in four different views shown at 140, 150, 160, and 170. The user may download each of these views as a computer file, such as a CSV, at 180. The user may also limit the data in each view by setting filters including future and past time ranges, state, basin, sub-basin, horizontal and vertical distance limits, and well ownership at 130. The wells can be displayed on the map or graphical user interface, showing the proximity of the different wells to the users' wells. This can use a proximity range set by the user as one of the data filters, or set by the system, for any well region or grouping. The upcoming well activity can also be limited by a variable time window as one of the data filters.

140 in FIG. 1 represents a dashboard view of individual well activities each displayed as a row of text and as a Gantt chart display. Users may click each row at 141 to view or open a table or other view of offsets to the particular well activity 142. In the expanded view of 142, the user may choose options to visualize data on a map 143, reschedule the dates of the activity 144, cancel the activity 145, download a CSV of displayed data 146, or send a note by email to all users of the offset wells 147.

150 in FIG. 1 represents a dashboard view of well activities organized as a grouping of wells (“well pads”) with each pad displayed as a row of text and as a Gantt chart display. Data for each well in a well pad is aggregated for the display. Users may click each row 151 to view or open a table or other view of each well activity occurring within the well pad 152 and the offset wells to the all well activity occurring on the pad 153. In the expanded view of 151, the user may choose options to visualize data on a map 154 or download a CSV of displayed data (155).

160 in FIG. 1 represents a dashboard view of offset wells affected by well activities with each offset well displayed as a row of text and as a Gantt chart display of well activity affecting the offset. Users may click each row 161 to view or open a table or other view of each well activity affecting the offset as a row and Gantt chart 162. In the expanded view of 161, the user may choose options to visualize data on a map 163 or download a CSV of displayed data 164.

170 in FIG. 1 represents a dashboard view of well activities organized as a grouping of offset wells (“offset well pads”) with each pad displayed as a row of text and well activity affecting wells of the offset well pad as a Gantt chart display. Data for each well in a well pad is aggregated for the display. Users may click each row 171 to view or open a table or other view of each well activity affecting one or more of the wells included within the well pad 172. In the expanded view of 171, the user may choose options to visualize data on a map 173 or download a CSV of displayed data 174.

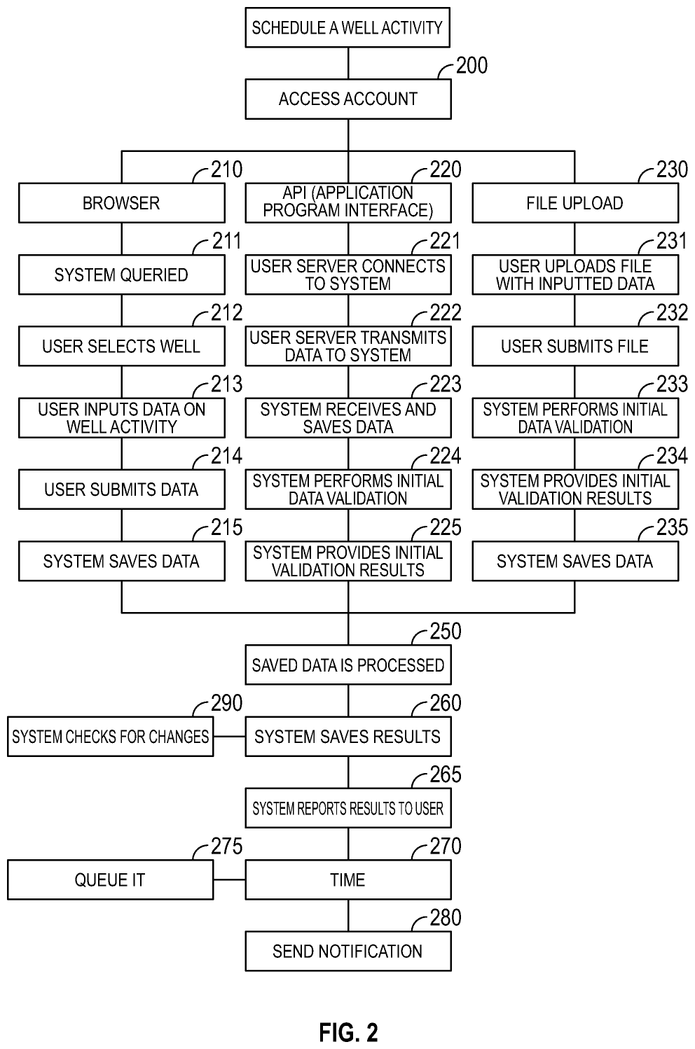

FIG. 2 illustrates how the user schedules well activity. At 200, the user accesses its account from a computer interface or server and chooses one or more methods to schedule one or more well activities.

At 210, the user uses a computer interface to schedule a single well activity. At 211, the system is queried to identify the user's wells. At 212, the user selects a well. At 213, the user provides data for one well activity including start and end dates, contact information, well location data, API number, well name, well pad name, and a note regarding the well activity. At 214, the user submits the data. At 215, the system saves the data, e.g. to a data queue.

At 220, the user uses an external server to access the system to schedule one or more well activities. At 221, the external server connects to the system. At 222, the user provides data for one well activity including start and end dates, contact information, well location data, API number, well name, well pad name, and a note regarding the well activity. At 223, the system saves the data, e.g. to a data queue. At 224, the user receives initial reporting on the actions of the system.

At 230, the user uses a combination of a computer interface and file upload, most often in a CSV format, to schedule one or more well activities. At 231, the user selects and uploads the file organized with data for one or more well activities with information on each well activity including start and end dates, contact information, well location data, API number, well name, well pad name, and a note regarding the well activity. At 232, user submits the file to the system. At 233, the system performs validation techniques on the data. At 234, the user receives initial reporting on the actions of the system. At 235, the system saves the data, e.g to a data queue.

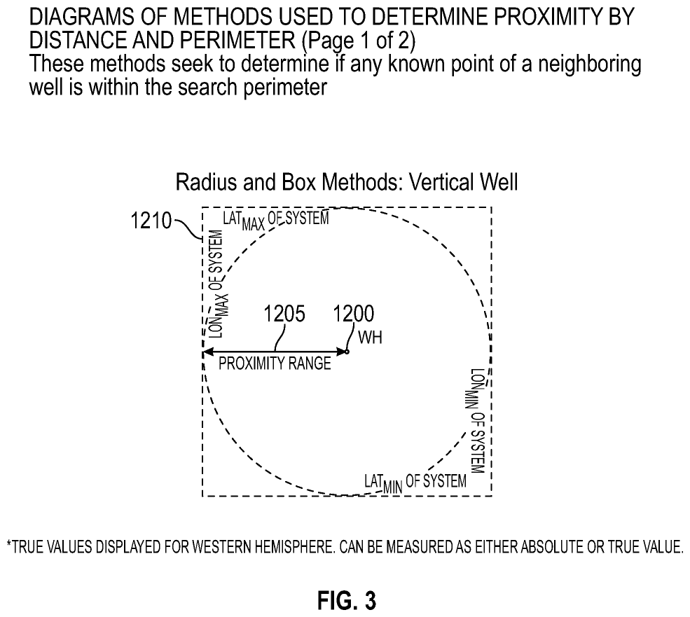

At 250, the system processes the saved data, which may be queued, to save the data regarding the well activity, determines offsets to the well activity by distance, and determines notification requirements as set by the system and/or the users. The analysis at 250 measures the proximity by distance or perimeter to other wells, as explained herein with reference to FIGS. 3, 4, 5, 6, and 7.

At 260, the system saves the data for the well activity, notification requirements, and the identification and resulting data for offset wells.

At 270, the system determines if any upcoming well activity is within a time window set by the system for notification of the users. That is, if an upcoming well activity is within the time window within which the user should be notified. If so, at 280, the system sends an electronic notification to the contact data associated with the well that is going to be affected by the offset well activity. The information can be electronic, such as email, telephone text or on screen, or can be physical such as a postal notification. If the notification time is outside the window, then the information is stored, retained or queued in the database for later sending at 275.

Secondary reminder notifications are set up on the system, so that periodic reminder notifications are sent, for example 48 hours before the well activity. The system continually may check its databases for wells to be affected by a scheduled, rescheduled or canceled well activity within the window, and continually sends those notifications when necessary.

In 290 of FIG. 2, the system may periodically check for changes to known data for offsets and/or to identify newly added wells as offsets, the data of which is again saved as in 260.

The system and/or users may impose a maximum outlook limit for viewing well activity and/or sending notifications. The system may send the notifications until the well activity date is within the outlook limit. For example, the system may limit views and/or send notifications for wells affected by well activity only within the next 60 days or otherwise set date and delay notifications until each affected well is within the outlook limit.

The system may send reminder notifications and/or summaries on a system- or user-set schedule. For example, the system may send a 48-hour notice to users for a well affected by a well activity originally scheduled before the 48-hour period.

A key feature of the system used herein is identifying neighboring wells that are “close” or “offset” to a well activity. Identification of an offset well is a process that uses multiple methods depending on the data available. The distance of interest can be between, for example, 0 feet, and 12500 feet. The techniques described herein determine if any known point of a neighboring well is within the search perimeter from a well activity. Initial detection of nearby wells is accomplished using a gross calculation which identifies candidate offset wells which are further analyzed for more precise distance according to the data available.

For a given well, the platform attempts to identify close offset wells at 800. Offset wells for which the distance calculation should be made are identified by a filter which only returns wells within a specified range using calculations based on well latitude and longitude data. This increases the efficiency of the process by only calculating distances for wells that are within that specified range.

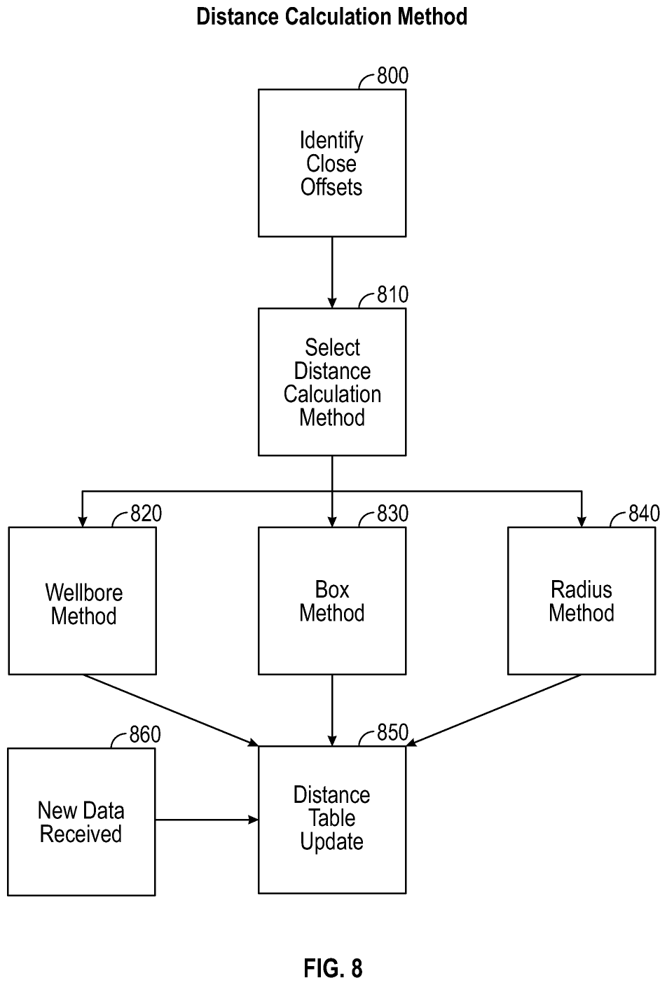

In an embodiment, the TracFrac platform uses multiple methods to calculate distances between wells, as illustrated in FIG. 8. After identification of the nearby wells 800, available data is evaluated 810 to assess the availability of either a shape file, surface hole and bottom hole, or surface hole only to calculate distances between wells. The wellbore method 820 is preferred over the box method 830 which is preferred over the radius method 840.

If available, a shapefile which defines the geometry of a given wellbore is used to calculate the distance to a nearby well. This finds the location of the wellbores and calculates the distance therebetween.

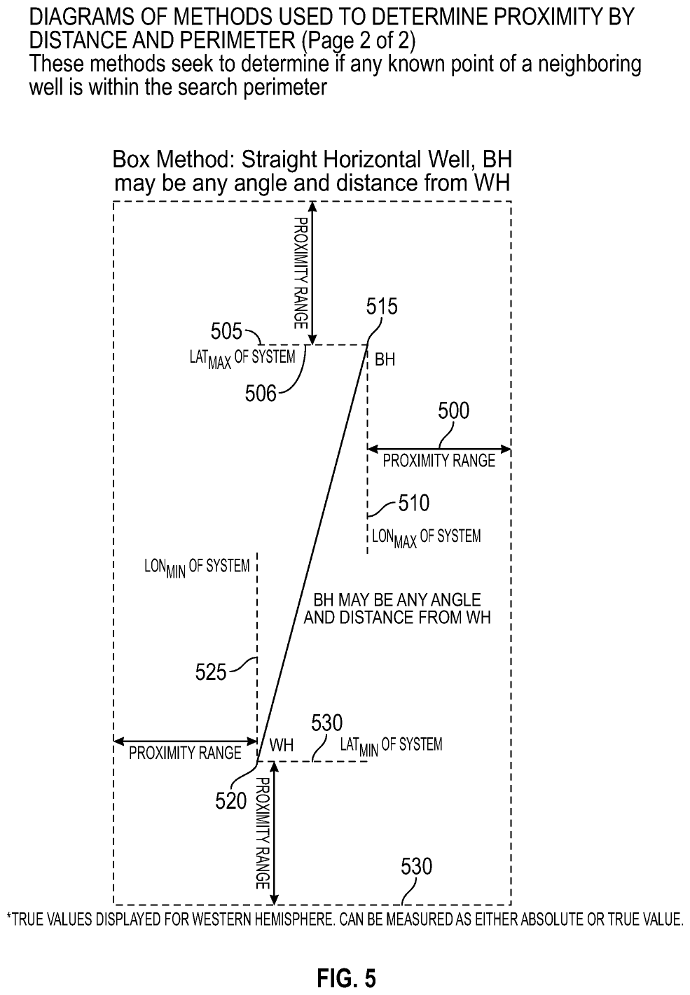

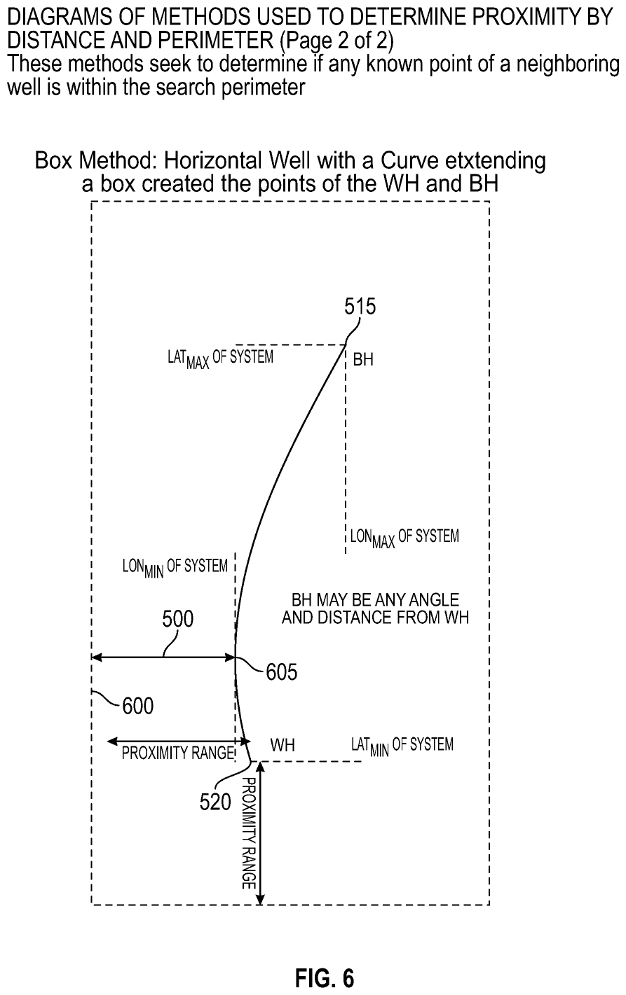

If a well does not have a shape file available, known locations of the well, most often surface hole and bottom hole locations, are used to define a box as in FIG. 5 or FIG. 6, which is used to approximate the well. For purposes of the calculation, it is assumed that the wellbore is contained within this box.

In the cases where a well only has a surface hole defined, this point is used in the calculation.

FIG. 3 illustrates the radius 840 and box 830 methods for a vertical well. In the vertical well, the well is at the location shown as 1200, and the proximity range can use either a radius 1205 from the vertical well top or can use a box 1210 defined around the area 1200 of the vertical well.

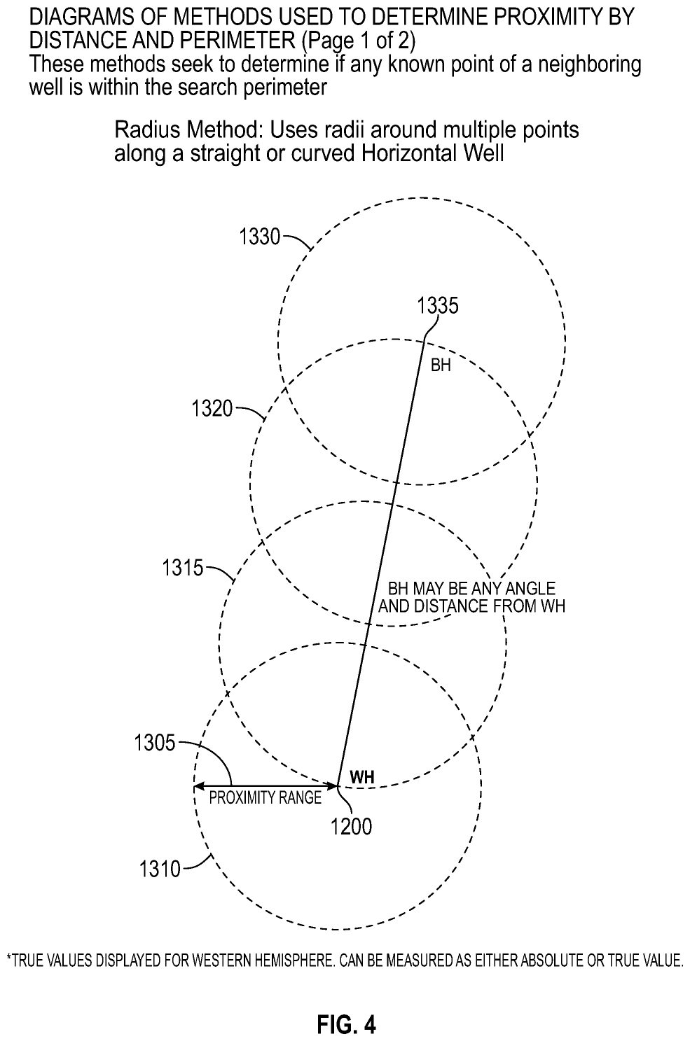

The radius method can also use radii of multiple points along a straight or curved horizontal well as shown in FIG. 4. For example, the location of the well shown as 1200 can have a proximity range of 1305 at the top portion of the curved well. This means that the area 1310 is the area at the top of the well. As the well curves downward, the curvature of the well is followed, making progressive radii of 1315, 1320 and 1330. 1330 is measured from the center of the well at the bottom of the well shown is BH1; point 1335.

All of these techniques seek to determine proximity by distance and perimeter to determine if any known point of a neighboring well is within the search perimeter. The search perimeter is shown in FIG. 5 as the proximity range 500. This is the distance, which can be set into the system, within which another well must be located. The well is defined as being between a top range 505 which is the maximum latitude of the well, and 510 which is a maximum longitude of the well. The well is defined as being between this point 515 at the maximum latitude and maximum longitude; and between another point 520 which is at the minimum longitude 525 of the well and the minimum latitude 530 of the well.

A line is defined at each of the maximum and minimum longitude and latitude. This line is used to set the proximity range. For example, the maximum latitude 505 defines a line shown as 506, and the proximity range 500 from the latitude line defines this line 506. In a similar way, proximity range between the minimum longitude 525 and the minimum latitude 530 defines a proximity range which surrounds the well. This proximity range defines a box shown as 530, and any other wells within that box are taken as being within the search perimeter, and as being wells that need to be notified of a neighboring hydraulic fracture.

FIG. 5 assumes a straight horizontal well. However, the angle and distance from between the top of the well and the bottom of the well can be any length and any angle.

FIG. 6 assumes that the well is curved that and the curve extends beyond the box created by the points of the well top 515 and the well bottom 520. By defining a curve in the well, the proximity range 520 at the bottom of the well 500 is actually inside the outer box perimeter 600. This outer box perimeter 600 for such a curved well is defined based on the proximity range of the part of the curve which extends furthest from the well top and/or bottom, shown as 605.

The shape file technique defines points along the wellbore path. Each consecutive pair of points defines a line segment. For two wells—well A and well B—each point of well B is compared to each line segment of well A and each point of well A is compared to each line segment of well B. The minimum distance is used to set the proximity.

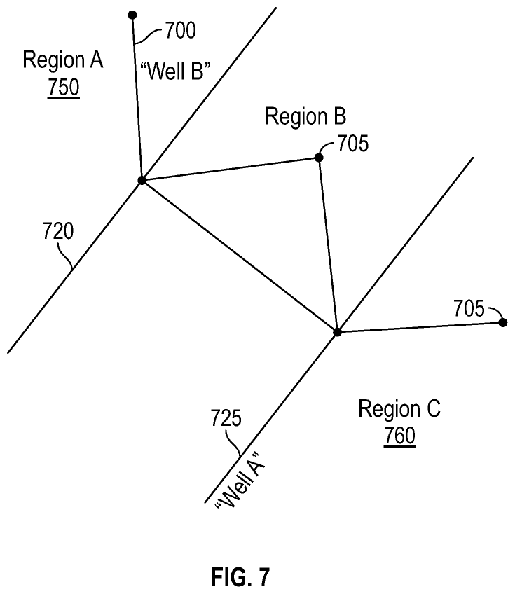

This is illustrated in FIG. 7, which shows the points 700, 705, 710, being the points of well B. FIG. 7 also shows the line segments 720 and 725 of well A. The distance between well A and well B is determined, in order to turn determine the proximity between the two wells.

The minimum distance between a point and a line segment is dependent on the angles of the triangle formed by the three points. First, the length of the sides of this triangle are calculated using the Haversine formula. The points of this triangle are given as latitude and longitude, and hence they define a spherical triangle, the sides of which are arc lengths. The haversine formula calculates the great-circle distance between each pair of points.

In an embodiment, these arc lengths are approximated as the sides of a triangle in a plane from this point onward. Within a 13-mile maximum distance, the error induced by this assumption is on the order of 4 inches. The side lengths are used to find the angles of the triangle.

These angles are used to identify whether the single point of one well lies closer to one of the endpoints of the line segment of the other well, or to the line segment itself, as shown in FIG. 7.

A point in either region A 750, or C 760 will always be closest to the end point of the line segment. For example, the point 700 which is in region A will be closer to the line segment 720, than it will be to the endpoints. If the point is in region B, the distance is the height of the triangle which is perpendicular to the line segment.

The law of cosines is used to find the region in which the point is located. If the point is in region A or C, the cosine of the angle between the line segment and the line from the nearest endpoint to the point will be negative. The cosine of the angle is given by:

$$cos ( θ ) = ( \frac{{a}^{2} + {b}^{2} - {c}^{2}}{2 a b} )$$

It is not necessary to calculate the inverse cosine itself, as the sign of the right-hand side of the above equation will tell the position of the point with respect to each end point.

If the point is in region A or C, the appropriate side length of the triangle is used directly. If the point is in region B, Heron's formula is used to calculate the height of the triangle using the 3 known side lengths.

Box Method:

If the surface and bottom hole is the only information available for a given well, a box described by the available latitude and longitude of each is used to describe a box with the following 4 points:

(Lat_{SH}, Lon_{SH}), (Lat_{SH}, Lon_{BH}) (Lat_{BH}, Lon_{BH}) (Lat_{BH}, Lon_{SH})

If multiple points are known, which may or may not be SH and BH, the maximum and minimum longitudinal and latitudinal values are used to create a box of four line segments with the points:

(Lat_{MAX}, Lon_{MAX}), (Lat_{MIN,} Lon_{MAX}) (Lat_{MAX}, Lon_{MIN}) (Lat_{MIN}, Lon_{MIN})

This box describes has four line segments which are compared to the points in either a shape file or box from a nearby well using the previously described point to line segment calculation.

An additional check is performed to ensure that a point from a neighboring well does not reside inside this box.

One Known Point

If a well has only a single point known point, this point is compared to the best available data of the nearby well prioritized as shape file first, box method second, and single point third.

Multiple Methods

Depending on the available data, a pair of wells may use a combination of the wellbore, box, or single point methods. The resultant distance will be tagged as WB:WB for wellbore to wellbore, WB:BOX for wellbore to box, WB:SH for wellbore to point, BOX:BOX for box to box, BOX:SH for box to point, or vice versa for each method.

Saving the DATA (850)

After the platform applies these methods to identify the shortest distance between two wells, the distance between the wells is saved to a distance table in a database. The distance from Well 1 to Well 2 and the distance from Well 2 to Well 1 is recorded in order to speed retrieval of the data.

The distance table is updated whenever a new analysis is completed. A new distance analysis will be performed when new location data becomes available (860) for a well in the form of updated locations or shape files that were previously missing.

The account parameters, as described above, can also be modified as described herein:

Modify personal and company details such as contact and billing details, as well as its commonly-known or general brand name.

Modify global proximity ranges and email addresses for notifications.

Modify states and/or regions in which to receive service. Each activity is limited to regions and/or states for which the user has a valid TracFrac license.

Modify a legal operating name which may be segregated by state and/or region. Each of these systems can be carried out on the specially programmed computer which is programmed to carry out each of these functions.

The above has described a more robust system of obtaining information regarding locations of oil and/or gas wells to be/or which have been scheduled for well activity and sending that information using the platform.

Another aspect describes a method that users can use to mark their wells as either prepared or prepared and protected for a nearby well activity.

This feature allows users to select a well, e.g. by its geolocation, indicate a preparation associated with that well, and then to indicate which other wells the preparation should apply towards. This is done because one well can be offset to several well activities in the nearby area. Any of those well activities may be operated by any of a number of different producers.

In an embodiment, this is done by a user responding to a prompt that asks how the well was prepped and asks manually for which well activity the preparation should apply.

In an embodiment, the user clicks an icon which initiates a prompt. As described above, the prompt asks how the well was prepared and which well activities apply to the well.

For example, the owner of well A can select well A and mark well A as being prepped to the well activities on wells B and C.

In addition, if some well owner does not use this platform, another operator can mark it as prepped for the well activities, if the operator has first hand knowledge, for example, that the hydraulic fracture preparation was already done.

Another technique describes a distance calculation which calculates the distance between wellbores.

When calculating distance between two wells, the TracFrac platform uses multiple methods depending on the available data. However, the wellbore to wellbore technique is preferred.

For a given pair of wells, wellbore data is used to calculate the distance if available. This finds the location of the wellbores, and calculates the distance therebetween.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer system comprising:
a database, enabling storing locations of multiple different wells, and storing said information of said multiple different wells;
a computer system, accepting entry of information, including a date on which an action will be taken on at least one of said wells;
said computer system determining information about other wells that are within a proximity of at least one of the said wells, said determining information comprising determining a perimeter of at least one well, determining one or more other wells which are within a proximity range to the perimeter of at least one well, and sending information to users associated with said other wells which are within the proximity range to the perimeter of the at least one well indicating the action which will occur and when the action will occur.

2. The system as in claim 1, wherein the action that will occur comprises a well activity of at least one well.

3. The system as in claim 1, wherein the perimeter is determined by forming a likely location of an extent of the well, and adding a proximity range to that likely location, to form the perimeter.

4. The system as in claim 1, wherein the proximity range is a setting that represents a distance between wells at which the action is likely to affect another well.

5. The system as in claim 3, wherein the perimeter is a rectangular box, formed between a maximum latitude and a maximum longitude of the well, and a minimum longitude and a minimum latitude of the well, forming a rectangle, and adding the proximity range all around that rectangle to form the perimeter of the box.

6. The system as in claim 3, wherein the perimeter is a rectangular box formed by finding a maximum longitude and a maximum latitude and a a minimum longitude and a minimum latitude, where at least one of the values represents an area of a curved well which does not extend straight from top to bottom, forming a rectangle between said maximum longitude and said maximum latitude and said minimum longitude and said minimum latitude, and adding the proximity range all around that rectangle to form the perimeter of the rectangle.

6. The system as in claim 3, wherein the perimeter is a square box around a postulated center of the vertical well.

7. The system as in claim 3, wherein the proximity range is formed around multiple points along a curved half of a horizontal well.

8. The system as in claim 3, wherein the distance is using wellbore geometry by defining a shape file that defines a detailed shape of the wellbore.

9. The system as in claim 2, wherein the well activity is a hydraulic fracturing.

10. The system as in claim 1, wherein the computer system provides notifications to offset well operators of actions that might affect the offset operators' wells, and to find information about upcoming well activities that could affect offset wells.
